(19) United States
(12) Patent Application Publication
(10) Pub. No.: US 2008/0016305 A1
(43) Pub. Date: Jan. 17, 2008

(54) Implementation of Soft Protections to Safeguard Program Execution

(75) Inventors: Chiahong Chen, Oro Valley, AZ (US); Daniel A. Heffley, Tucson, AZ (US); Russell L. Lewis, Tucson, AZ (US)

Correspondence Address: QUARLES & BRADY LLP, 1 SOUTH CHURCH AVENUE, SUITE 1700, TUCSON, AZ, 85701, US

(73) Assignee: International Business Machines Corporation, Armonk, NY (US)

(21) Appl. No.: 11/457,093

(22) Filed: Jul. 12, 2006

(51) Int. Cl. G06F 12/14; G06F 12/00

(52) U.S. Cl. 711/163; 711/170

(57) ABSTRACT

A program executing on a computer system implements a soft protection by allocating a region of memory in the computer system, initializing a soft protection on a page in the region of memory, detecting a use of the page having the soft protection, receiving a signal from an operating system executing on the computer system, and determining if the signal is masked off. An operating system module executes on a computer system for implementing a soft protection. The operating system module includes an initialization module for allocating memory, a settings module for saving a previous soft protection setting, a detection module for detecting a page fault, and an execution module for setting a notification signal, clearing the soft protection and restoring page permissions.

### BACKGROUND OF THE INVENTION

1. Field of the Invention

The present invention relates in general to computers, and, more particularly, to a system and method within a computer system running an operating system for implementing a soft protection to safeguard execution of a program or process operating on the computer system.

2. Description of the Prior Art

Threads in a computer program often use a “stack” to keep track of the state of the thread. Sometimes, the program encounters a condition known as “stack overflow,” where it uses all of the available stack. Typically, the operating system will cause a Segmentation Violation (SEGV) or an equivalent error to be reported to that thread. However, given that the stack is exhausted, it is often impossible to handle this error. Thus, the error often causes the thread (and perhaps the entire computer program) to be terminated.

Sometimes, the operating system provides some sort of alternate mechanism to handle a stack overflow condition. For instance, on Linux a system call referred to as “sigaltstack” declares an alternate location in memory which is used as the thread's stack. This alternate location or “alt stack” is used as the thread's stack only while handling stack overflow. If a stack overflow SEGV is encountered, then this signal is delivered on the alternate stack. However, the implementation of sigaltstack is problematic for several reasons. Sometimes, code accesses the stack pointer for various reasons. For example, a thread library might read the stack pointer in order to determine what thread is executing. If sigaltstack is a process-global property, then it is impossible to determine what thread is executing when the thread is on the alternate stack. In addition, some exception handling code copies regions from the stack. If the stack is broken into two discontinuous regions, the exception handling code may not work as designed.

The implementation of sigaltstack can also be problematic due to several issues. First, additional memory is necessary to be allocated and managed. Secondly, the alternate stack area cannot be used for normal stack use, even if the program would like to ignore the stack overflow and attempt to continue. Thirdly, it is impossible to mask the signal in order to delay its handling. Fourthly, some implementations make sigaltstack a process-wide variable instead of thread-specific. As a result, it may not be possible to handle simultaneous stack overflows on multiple threads.

Stack overflow mechanisms, as described above, are specialized forms of what may be called “hard” memory protections. These protections disallow access to certain pages of memory; if the pages are accessed, then a signal is immediately delivered and the program must handle the condition before continuing. A need exists for an effective system and method to implement “soft” protections, which are protections where the program is allowed to access the memory, but a warning (the handling of which may be deferred) is sent when this first occurs.

### SUMMARY OF THE INVENTION

In one embodiment the present invention is a method of implementing a soft protection by a program executing on a computer system, comprising allocating a region of memory in the computer system, initializing a soft protection on a page in the region of memory; detecting a use of the page having the soft protection, receiving a signal from an operating system executing on the computer system, and determining if the signal is masked off, wherein if the signal is not masked off a signal handler in the program executes.

In another embodiment the present invention is an operating system module executing on a computer system for implementing a soft protection, comprising an initialization module which initializes a memory allocation in the computer system without the soft protection, a settings module following the initialization module which saves a previous protection setting and initializes an effective setting to match a current setting of the soft protection, a detection module following the settings module which identifies whether the soft protection was enabled, and an execution module following the detection module which sets a signal, clears the soft protection, and restores page permissions.

In still another embodiment, the present invention is a method of implementing a stack overflow notification for a program, comprising determining if a page fault has occurred, determining if a predefined stack warning value has been set for a thread in the program, determining if a stack extension invades a predefined stack warning area, and receiving a stack warning signal to the thread.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an example computer system;

FIG. 2 illustrates a stack overflow warning example of a soft protection for use in a computer system;

FIG. 3 illustrates an example method of operation of a soft protection system by an operating system executing on a computer system; and

FIG. 4 illustrates an example method of operation of a soft protection by a program executing in conjunction with an operating system on a computer system.

### DETAILED DESCRIPTION OF THE DRAWINGS

Some of the functional units described in this specification have been labeled as modules in order to particularly emphasize their implementation independence. Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

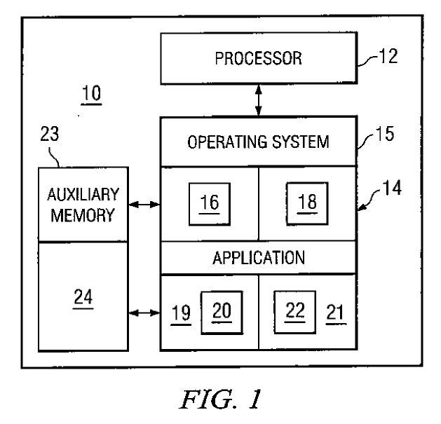

An example computer system 10 is presented in FIG. 1. Computer system 10 can generally include any type of computer system, including, but not limited to, a computer system based on a microprocessor, a mainframe computer, a digital signal processor, a portable computing device, a personal organizer, a device controller, and a computational engine within an appliance.

Computer system 10 includes processor 12 and main memory 14. Memory 14 can include any type of memory within a computer system. Memory 14 includes operating system 15. In addition, memory 14 includes applications 19, 21 which execute on top of operating system 15. Application 19 includes a user stack 20, which contains stack pages for procedure calls executed by application 19. Additionally, application 21 includes user stack 22, which contains stack pages for procedure calls executed by application 21.

Operating system 15 includes kernel stacks 16, 18. Kernel stack 16 contains stack pages for operating system calls associated with the execution of application 19. Kernel stack 18 contains stack pages for operating system calls associated with the execution of application 21. Finally, computer system 10 includes auxiliary or alternate memory 23. Memory 23 includes alternate memory module 24. Memory 23 with module 24 can be physically integrated into main memory 14, but are shown individually for purposes of illustration.

In accordance with an embodiment of the present invention, a mechanism is described whereby a program or application 19, 21 can disable access to a stack page at any memory location, such as alternate memory 23, main memory 14, a virtual memory location located as part of computer system 10 or elsewhere. The page can be part of any stack page as previously described. In addition, the page can be located as part of any other memory region. This mechanism can be referred to as a “soft protection” or “soft guard”. Generally, a soft guard or soft protection is put in place to ensure that applications 19, 21, executing in conjunction with operating system 15 as located on computer system 10, continue to function properly, particularly to prevent the applications 19, 21 from running out of available memory or similar.

A special case of a soft guard is presently described. “Stack overflow warnings” are a special case of soft guard pages. Programs 19, 21 can set up a stack overflow warning by setting a soft guard on the last few (or many) pages of their stacks 20, 22. By implementing a soft guard, a mechanism is put into place whereby programs 19, 21 can get notified (via a signal) when the programs 19, 21 first use a certain portion of their stacks 20, 22. Once the signal is queued up inside the kernel of operating system 15, the kernel turns on access to those pages of the stacks 20, 22. As a result, it is possible for programs 19, 21 to get warnings when they near the end of the stacks 20, 22, but before the programs 19, 21 actually run out of available stack space. The programs 19, 21 can handle the signal on their stacks 20, 22. This eliminates the need for sigaltstack( ). Additionally, the signal can be masked off temporarily. Thus, the programs 19, 21 can delay handling the signal until a convenient time.

By implementing a stack overflow warning method, processes are given the ability to declare a “stack warning”. Processes which undesirably come close to the end of their stack are sent some sort of signal. Again, however, this signal can be handled on the stack area that remains, rather than on an alternate stack. If the program continues on and consumes the rest of the stack despite the warning, then the program will result in a true stack overflow, which is a generally a terminal condition for the thread. In one embodiment, once stack warning is sent (that is, as soon as the signal is queued), a warning value is cleared, so that the thread wilt not receive additional warnings, even if the thread returns down below the stack warning threshold and returns back up. However, the thread can re-establish (or de-establish, or alter) the stack warning value at any time.

This process is superior to sigaltstack( ) primarily because it causes the signal to be handled on the stack itself, and not on some other stack somewhere else in memory. As a result, the problems previously described using sigaltstack( ) are alleviated. First, the stack pointer, even when handling a stack warning, is always inside the normal stack for this process. As such, any code that uses the stack pointer would continue to function properly. Secondly, no additional memory is required to be allocated. Again, existing stack is utilized. Thirdly, the stack waning signal can be masked off and handled later, since this signal is non-critical. Fourth, the stack can go ahead and use some of the stack warning area for normal use. This can be accomplished by either handling the signal, returning, and not re-establishing the stack warning, or by masking off the signal, so that it is not delivered during a certain window of time. Finally, the stack warning is inherently thread-specific. A stack warning for a given thread is automatically handled on that thread. Thus, multiple stacks can overflow without incident.

The application of the present invention includes a slight risk of a single known drawback. In some very rare applications, it may be necessary to increase the total size of the stack to make space for the stack warning area on top of existing stack, but most applications do not require stack usage in this manner

In one embodiment, the stack warning process in accordance with the present invention makes use of the Linux kernel in a Linux operating system operating on computer system 10. On Linux, memory ranges are generally maintained with Virtual Memory Area structures (VMAs). Each thread in a process has a VMA which represents the stack used by that thread. Each stack VMA starts out very small, but with a flag that indicates that it is valid to extend its size. Whenever the thread uses a page on the stack that has never been used before, a page fault results. Linux sees that this is within the valid stack range for this stack, and extends the VMA (which informs the memory layer that it may now assign physical pages to these locations). When a page fault occurs which would require that the stack be extended further than is allowed for the particular thread, Linux sends a SEGV to this process. This SEGV may kill the thread, or, if sigaltstack( ) has been set up, then it may be handled on the alternate stack.

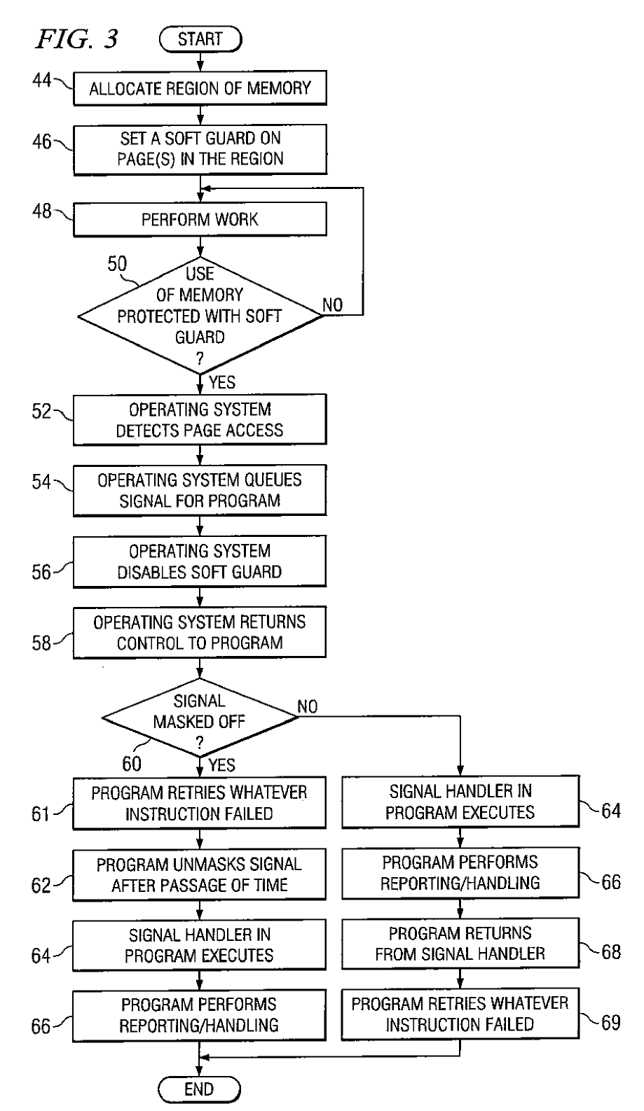

The present invention alters the stack-extension process described above. Turning to FIG. 3, an example stack warning soft guard implementation is seen in accordance with an embodiment of the present invention. A thread uses a page on a stack resulting in a page fault (step 26). If the page is beyond the legal limits for this thread (step 28), the kernel sends a SEGV to the thread (step 30) as previously described. If the page is not beyond the legal limits for this thread (again, step 28), the stack is extended (step 32). If the operating system determines that a stack warning has been set for this thread (step 34), and the stack extension in step 32 invades the warning area (step 36), then the kernel sends a stack waning to the thread (step 38). If the signal is masked off (step 40), the signal is queued for later delivery (step 43). If the signal is not masked off, the signal is handled immediately (step 42).

Per step 34, the stack warning value can be stored in a thread-specific kernel structure (task_struct, in the case of Linux). The value can be an integer which indicates the number of pages of warning that are desired. The value can be anything from zero (0) (no warning) to one (1) less than the maximum size of the stack in pages. Any time that the stack warning is triggered, the value is reset to zero (0) so that additional stack warnings are not triggered in the future. Other embodiments of the present invention can encode the stack warning value in other fashions, such as storing the maximum stack size before a warning occurs, storing the value in terms of bytes, or other variants.

The stack warning value defaults to zero (0) so that legacy applications will see no change in behavior. However, a user can set the stack warning value at any time to any valid number. The user can disable the stack warning by setting the value to zero (0). The user can reduce the stack warning value by setting the value to something less than before. The user can set the value to the current value (no change). The user can establish an initial stack warning value, or re-establish a value after the value has been reset to zero. Finally, the user can increase the stack warning value by setting it to something more than before.

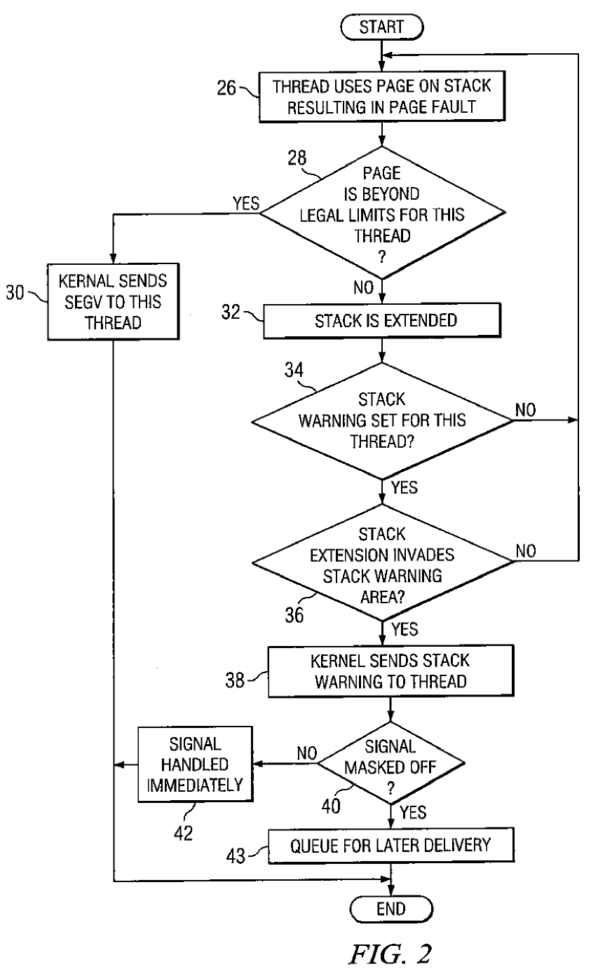

In cases where the stack warning value is disabled, reduced, or set to the current value as described above, the stack warning value is being reduced, eliminated or not changed. These cases do not require any special processing or overhead. In cases where an initial stack warning value is established, or the stack warning value is increased, the user increases the stack warning size. As a result, it is possible that the stack might already violate the new, more restrictive warning value. In cases where the size in the current stack VMA does not cross the new stack warning, additional action is not required. In cases where the current stack VMA crosses the stack warning, but the current active stack does not, the OS can crop the stack area down to something below the stack warning value. This entails shortening the size in the VMA, and removing page table entries. Thus, any future operation that uses memory in the stack warning area will trigger a page fault and the stack warning signal process described in FIG. 2.

In cases where the current stack VMA crosses the stack warning and the current active stack crosses the stack warning, the stack warning triggers immediately. As a result, the stack warning value is set to the new value, the stack warning signal is sent or queued to be sent, the stack warning value is reset to zero (0) and the thread returns to user mode and the user has the chance to handle the signal.

The stack warning value can be set through any appropriate mechanism. In one embodiment, a file in/proc/<pid>/is implemented. However, other implementations can use ioctl's, system calls, or other interfaces. It is implementation dependent whether other threads can set or read the stack warning value. In one embodiment, only the thread itself can change the value. Other operations in the system can indirectly cause a stack warning to be sent. For example, if the allowable stack size is reduced, a stack warning can be immediately triggered. Other conditions may exists in various implementations and embodiments of the present invention.

The use of a stack warning process and sigaltstack( ) need not be exclusive. It is technically possible for a single thread to use both. However, it is expected that most threads will use one or the other, as the two mechanisms provide largely overlapping functionality. Therefore, some implementations may not allow a single thread to use both mechanisms.

Again, the implementation of a stack warning mechanism as described is an example embodiment of a soft guard or soft protection. It is possible, however, to implement soft guards or soft protection mechanisms which provide protection by disabling access to any page located as part of the stack, or as part of any other memory region, instead of simply disabling access to the stack. Moreover, it is possible to disable only certain types of access. For example, it is possible to take a writable page and set a soft guard only on writing, meaning that you can read the page without triggering any alert.

A soft guard, like the specialized case of a stack overflow warning process described in FIG. 2, can mask off the signal associated with the soft guard and delay handling until a convenient time. Additionally, like stack overflow warnings, once a soft guard is violated, the guard is disabled. If the program wants to catch future accesses then the program must reset the guard. As a result, stack overflow warnings are simply a special case of soft guard pages. A program can set up a stack overflow warning by setting a soft guard on the last few (or many) pages of its stack. The program will get a signal when it first violates the soft guard.

Some operating systems allow a program to mark a page as readable without making the page executable. In this case, a soft guard can be set up to disable execute permissions, while still allowing read permissions.

Soft guards can have implementation-dependent properties which are addressed by a preferred embodiment of the present invention as follows. First, if a program sets a soft guard on a region of memory which includes multiple pages, and then accesses one of those pages causing the soft guard signal to fire, then it is implementation dependent whether the guard is disabled on just that page, or if it is disabled on all pages in the region. A preferred embodiment of the invention then disables the soft guard on all pages in the region the first time that the soft guard is triggered for any page.

Secondly, if a program sets a soft guard on a region of memory, and it disables multiples types of access (such as disabling both read and write), and it then accesses a page with one type of access (such as reading one page), then it is implementation dependent whether the guard is totally disabled, or if it is disabled only for that type of access. A preferred embodiment of the invention then disables the guard entirely the first time that it is triggered for any type of use.

Third, some operating systems allow a program to temporarily disable certain types of access to a page (such as the mprotect( ) system call on Linux). This action can be referred to as a “hard guard”. It is not automatically re-enabled when triggered, and the signal cannot be masked off. Normally, it is possible to re-enable access to a page at a later time. A program may attempt to set a soft guard on a type of access which has already been disabled with a hard guard. Likewise, a hard guard may be set for a type of access that is already protected by a soft guard. A preferred embodiment of the invention prevents soft guards to be set on types of access which are already protected with a hard guard. If the program attempts to set a hard guard on a region of memory which already has a soft guard, then the soft guard is discarded and the new, hard guard is set.

Fourth, a program can set a soft guard on a region of memory which already has a soft guard, but each guard covers different types of access. A preferred embodiment merges the two guards together. A soft guard is set which protects all of the types of access which were covered by either of the guards.

Finally, a program can set a soft guard on a region of memory which already has a soft guard, and the soft guards have some types of access in common. Again, a preferred embodiment merges the two guards together as previously.

Turning to FIG. 3, an example process of implementing a soft guard by a program is presented in accordance with an embodiment of the present invention. The program allocates a region of memory (step 44). A soft guard is set on one or more pages in that region (step 46). Next, some work is performed (step 48). At some future time, the program uses memory protected with the soft guard, using it in a way that was disallowed by the soft guard (step 50). When this occurs, the operating system detects the page access (step 52), queues up a signal for the program (step 54), and then disables the soft guard (step 56), giving the program access to the page. The operating system then returns control to the program (step 58). Two possible sequences result, based on whether or not the signal was masked off. If the signal was not masked off (step 60), then the signal is handled immediately. The signal is delivered and a signal handler in the program executes (step 64). The program does any reporting or handling that it may want (step 66). Finally, the program returns from the signal handler (step 68). The program then retries whatever instruction failed last time because of the soft guard (step 69). If the signal is masked off, the program first retries whatever instruction failed last time because of the soft guard (step 61). This time, it works because the soft guard has been removed. The program then unmasks the signal after a passage of time (step 62), and performs the signal handling processes (steps 64,66).

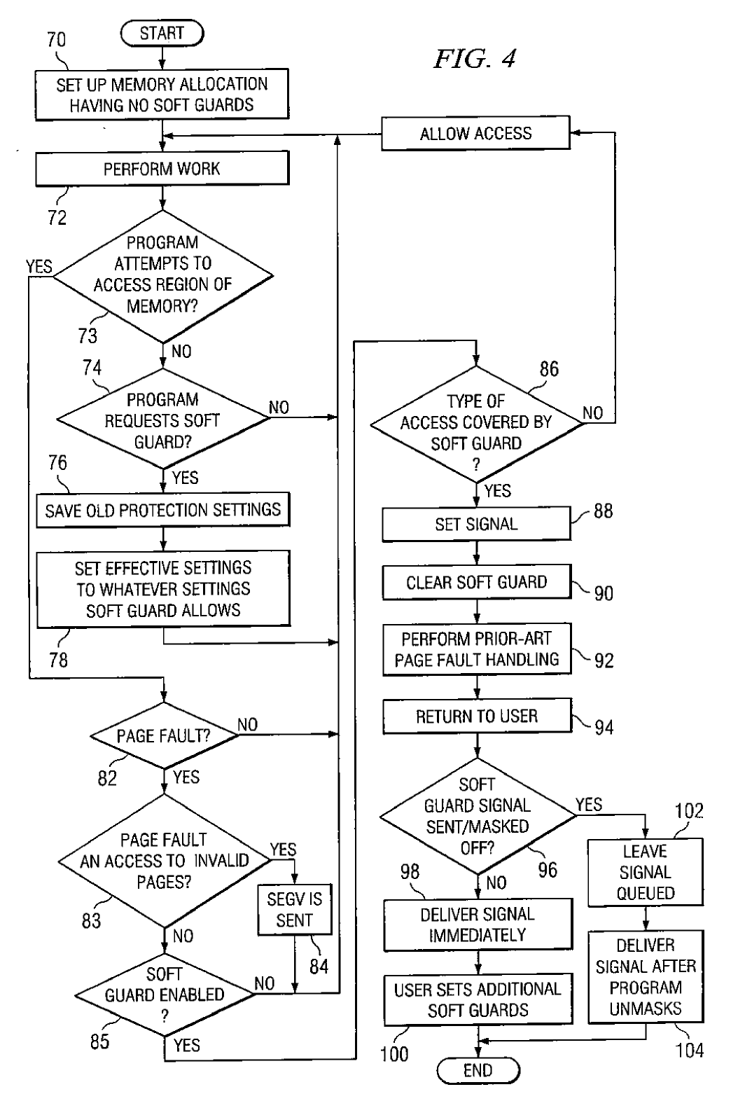

Turning to FIG. 4, an example process of implementing a soft guard by an operating system is presented in accordance with an embodiment of the present invention. As a preliminary step, whenever a region of memory is allocated by any program, the operating system sets up the allocation without soft guards (step 70). This allocation can be implemented using an initialization module executing on computer system 10. The operating system then performs work (step 72). The program may attempt to access a region of memory (step 73), or the program may request a soft guard (step 74). If the program does not request a soft guard, the program continues to perform work. Steps 73 and 74 do not have to be performed sequentially; the steps may be performed in reverse order. If a program requests a soft guard (again, step 74), the operating system saves the old protection settings (step 76) and sets the effective settings to whatever the soft guard allows (step 78). These settings functions can be implemented using a settings module also executing on computer system 10. After performing these settings functions, the program continues to perform work.

If a program does attempt to access a region of memory (again, step 73), and a page fault results (step 82) that was an access to invalid pages (step 83), then a SEGV is sent to this thread (step 84). If a program attempts to access a region of memory (step 73) that does not result in a page fault (step 82), then the program again continues to perform work. If a page fault (step 82) was not the result of an access to an invalid page (step 83), the operating system checks to see if that region has a soft guard enabled (step 85). If the type of access is not covered by the soft guard (step 86), then the operating system allows access and the program continues to perform work. The detection steps can be performed by a detection module executing on system 10.

If the detection module determines that type of access is something covered by the soft guard (again, step 86), then the operating system sets the signal (step 88), clears the soft guard and restores that page's permissions to whatever they had been before (step 90). Such execution steps can be implemented by use of an implementation module. As a next step, the operating system performs prior-art page fault handling (step 92) by use of a handling module. Note, however, that the soft guard code in step 90 may have altered the page's permissions. As a result, the access may be legal access.

After performing page fault handling (step 92), the operating system then returns to the user (step 94) making use of a return module. If a soft guard signal was sent and it is not currently masked off (step 96), then the operating system delivers the signal immediately (step 98). Otherwise, the signal is left queued (step 102) and delivered after the program unmasks the signal (step 104). Finally, in step 100, a user may set additional soft guards in the future.

Various modules as previously described can work independently or in concert to bring about preferred embodiments of the present invention. For example, the detection module can be operable to determine whether a hard guard or hard protection covers the same allocation in memory as a soft protection, or whether two soft protections cover different types of access as previously described. Likewise, the settings module can be operable to merge hard and soft protections or merge two or more soft protections.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method of implementing a soft protection by a program executing on a computer system, comprising:
allocating a region of memory in the computer system;
initializing a soft protection on a page in the region of memory;
detecting a use of the page having the soft protection;
receiving a first signal from an operating system executing on the computer system; and
determining if the signal is masked off, wherein if the signal is not masked off a signal handler in the program executes.

2. The method of claim 1, wherein detecting the use of the page having the soft protection is performed by an operating system executing on the computer system.

3. The method of claim 2, further including queuing a second signal for the program by the operating system.

4. The method of claim 3, further including disabling the soft protection by the operating system to give the program access to the page.

5. The method of claim 4, further including returning control to the program by the operating system.

6. The method of claim 1, further including performing reporting or handling.

7. The method of claim 6, further including returning from the signal handler once the reporting or handling is completed.

8. An operating system module executing on a computer system for implementing a soft protection, comprising:
an initialization module which initializes a memory allocation in the computer system without the soft protection;
a settings module following the initialization module which saves a previous protection setting and initializes an effective setting to match a current setting of the soft protection;
a detection module following the settings module which identifies whether the soft protection was enabled; and
an execution module following the detection module which sets a signal, clears the soft protection, and restores page permissions.

9. The module of claim 8, further including a handling module following the settings module for performing page fault handling.

10. The module of claim 9, further including a return module following the handling module for returning control of the computer system to a user, wherein the return module delivers a signal to a program executing on the computer system.

11. The module of claim 10, wherein if the return module determines the signal to be masked off; the signal is queued for later delivery.

12. The module of claim 8, wherein the detection module is operable to determine whether a hard protection and the soft protection coincide in a single memory allocation.

13. The module of claim 12, wherein the settings module is operable to merge the hard and soft protections.

14. A method of implementing a stack overflow notification for a program, comprising:
determining if a page fault has occurred;
determining if a predefined stack warning value has been set for a thread in the program;
determining if a stack extension invades a predefined stack warning area; and
receiving a stack warning signal to the thread.

15. The method of claim 14, further including determining if the stack warning signal is masked off.

16. The method of claim 15, further including performing signal handling.

17. The method of claim 16, wherein the signal handling is immediately performed upon a determination that the stack warning signal is not masked off.

18. The method of claim 15, wherein the signal is queued upon a determination that the stack warning signal is masked off.

19. The method of claim 14, wherein the stack warning signal is sent to the thread via an operating system kernel.
